(19) United States
(12) Patent Application Publication
(10) Pub. No.: US 2026/0087492 A1
(43) Pub. Date: Mar. 26, 2026

(54) AI AGENT SYSTEM ENABLING LLMS FOR FINANCIAL TRANSACTIONS AND AUTONOMOUS AGENT SERVICES THROUGH BLOCKCHAIN TECHNOLOGY

(71) Applicant: Derek Edwin Pappas, Sheridan, WY (US)

(72) Inventor: Derek Edwin Pappas, Sheridan, WY (US)

(21) Appl. No.: 19/340,733

(22) Filed: Sep. 25, 2025

Related U.S. Application Data
(60) Provisional application No. 63/698,988, filed on Sep. 25, 2024.

(51) Int. Cl. G06Q 20/38

(52) U.S. Cl. CPC G06Q 20/389

(57) ABSTRACT

A computer system comprising a processor; a memory; and a non-volatile storage device; wherein the computer system comprises computer-executed instructions configured to execute a software platform comprising: a blockchain layer, and an agent orchestrator, wherein the agent orchestrator is configured to conduct one or more financial transactions via one or more AI agents; and wherein the system records the financial transaction events on the blockchain layer.

### CROSS-REFERENCE TO RELATED APPLICATIONS

This application claims the benefit of U.S. Provisional Application No. 63/698,988, filed Sep. 25, 2024, which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### TECHNICAL FIELD

This system relates to artificial intelligence, financial services, and blockchain technology. Specifically, it concerns a system that enables large language models (LLMs) to autonomously execute secure financial transactions and manage service agreements on a blockchain network, encompassing agent-to-agent transactions, agent-to-human interactions, and integration with traditional banking systems.

The subject matter relates to artificial intelligence, financial technology, and distributed systems, and more particularly to systems and methods that enable autonomous and semi-autonomous agents (such as large language model (LLM) agents) to negotiate, form, execute, verify, and settle service contracts and financial transactions using blockchain anchoring, multi-rail treasury integrations, policy guardrails, and auditable evidence.

### BACKGROUND

While LLMs are increasingly being applied to automate customer service, payment processing, and financial management, a system enabling LLMs to autonomously negotiate, execute, and manage financial agreements in a decentralized manner on the blockchain has not been developed. This system addresses the need for a secure, consensus-driven platform that allows autonomous agents to manage financial transactions, including agent-to-agent service contracts, milestone tracking, fraud detection, and quality verification, with seamless integration to banking and payment services.

The widespread use of large language models (LLMs) by third-party applications for services such as chatbots, content generation, and automation tasks often involves significant computational resources. Traditionally, third-party applications using LLM services either absorb these costs or charge users in a more generalized subscription model. However, this system can lead to financial burdens on the third party or result in inefficient cost distribution.

The problem arises in securely delegating LLM usage and billing to the end user, where the user maintains control over both their data and the costs incurred by their interactions with the LLM. Present solutions fail to offer a direct, secure, and efficient method to enable third parties to access LLMs while transparently billing users for the associated costs. The need exists for a secure mechanism that allows users to provide encrypted keys to third-party applications for LLM usage, enabling the LLM service to authenticate, approve, and bill the user directly for any charges.

Conventional automation stacks struggle to (i) negotiate at scale with integrity protections, (ii) hold conditional funds pending verifiable performance, (iii) execute multi-rail payouts (including pass-through and split settlements) atomically, and (iv) preserve tamper-evident proofs adequate for audit and dispute resolution.

Metered decrement, subscription dunning, KYC gating, FX, and bridging are scattered and unauditable. Subscription dunning, KYC/KYB gating, metered decrement with proofs, and SLA credit issuance are fragmented across services with weak provenance. An improved, agent-first substrate is needed that encodes contracts and value objects as programmable artifacts, enforces guardrails and consent, executes rail-agnostic settlements, and anchors evidence on a consensus ledger.

Considering the foregoing, disclosed herein are systems and methods for AI agent system enabling LLMs for financial transactions and autonomous agent services through blockchain technology.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an overview of an AI agent system enabling LLMs for financial transactions and autonomous agent services through blockchain technology according to the principles of the present disclosure;

FIG. 2 is a schematic block diagram illustrating an overview of a software platform for facilitating financial transactions and autonomous agent services according to the principles of the present disclosure;

FIG. 2A is a schematic block diagram illustrating a smart contract manager and components thereof of a software platform for facilitating financial transactions and autonomous agent services according to the principles of the present disclosure;

FIG. 2B is a schematic block diagram illustrating an agent orchestrator module and components thereof of a software platform for facilitating financial transactions and autonomous agent services according to the principles of the present disclosure;

FIG. 2C is a schematic block diagram illustrating a billing & metering module and components thereof of a software platform for facilitating financial transactions and autonomous agent services according to the principles of the present disclosure;

FIG. 2D is a schematic block diagram illustrating a payments adapter module and components thereof of a software platform for facilitating financial transactions and autonomous agent services according to the principles of the present disclosure;

FIG. 3 is a schematic block diagram illustrating system architecture hardware for hosting, accessing, and/or running a software platform for facilitating financial transactions and autonomous agent services according to the principles of the present disclosure;

FIG. 4 is a schematic block diagram illustrating a treasury or wallet component of a system running a platform for facilitating financial transactions and autonomous agent services according to the principles of the present disclosure;

FIG. 5 is a schematic block diagram illustrating AI agent components of a system running a platform for facilitating financial transactions and autonomous agent services according to the principles of the present disclosure;

FIG. 6 is a flowchart diagram illustrating a flowchart diagram of a negotiation, compilation, and funding operation of a platform for facilitating financial transactions and autonomous agent services according to the principles of the present disclosure;

FIG. 7 is a flowchart diagram illustrating a milestone verification and release operation of a platform for facilitating financial transactions and autonomous agent services according to the principles of the present disclosure;

FIG. 8 is a flowchart diagram illustrating a dispute, refund, and reputation update operation of a platform for facilitating financial transactions and autonomous agent services according to the principles of the present disclosure;

FIG. 9 is a flowchart diagram illustrating a subscription billing and dunning flow operation of a platform for facilitating financial transactions and autonomous agent services according to the principles of the present disclosure;

FIG. 10 is a flowchart diagram illustrating a cross-chain settlement and service level agreement operation of a platform for facilitating financial transactions and autonomous agent services according to the principles of the present disclosure;

FIG. 11 is a flowchart diagram illustrating a directory, shortlisting, and reverse auction operation of a platform for facilitating financial transactions and autonomous agent services according to the principles of the present disclosure;

FIG. 12 is a flowchart diagram illustrating a treasury rails and route selection operation of a platform for facilitating financial transactions and autonomous agent services according to the principles of the present disclosure;

FIG. 13 is a flowchart diagram illustrating an arbitration and refund workflow operation of a platform for facilitating financial transactions and autonomous agent services according to the principles of the present disclosure;

FIG. 14 is a flowchart diagram illustrating a metered billing and deposit decrement operation of a platform for facilitating financial transactions and autonomous agent services according to the principles of the present disclosure;

FIG. 15 is a flowchart diagram illustrating a retainer and service level agreement credit operation of a platform for facilitating financial transactions and autonomous agent services according to the principles of the present disclosure.

### DETAILED DESCRIPTION

An AI Agent System that enables large language model (LLM) agents to autonomously execute secure financial transactions and manage service contracts on a blockchain is disclosed herein. This system facilitates agent-to-agent and agent-to-human transactions, incorporating negotiation, digital contracts, milestone tracking, and fraud detection. The system leverages blockchain consensus for authentication and identity management and integrates with banking services for multi-payment support. It is compatible with frameworks like LangChain and Vercel's AI SDK, and other available and similar future frameworks enabling programmable transaction control for autonomous financial service delivery.

The system introduces a User-Encrypted Key System for Third-Party Applications with Billing Integration. This system enables third-party applications, in addition to AI agents, to securely access large language model (LLM) services using user-encrypted keys while billing the user directly for any associated costs. The system provides users with control over permissions, spending limits, and transaction audits, ensuring transparency and security in third-party interactions with LLM services.

An AI Agent system enabling large language model agents to autonomously negotiate, execute, and settle financial transactions and service contracts on a blockchain with integrated payment rails. The AI agent system may include a computer system that includes a processor, main memory, non-volatile storage, and a network interface connected to the Internet and Remote Services/Servers. Platform modules comprise a blockchain layer, smart-contract manager, agent orchestrator, billing & metering, payments adapter, risk & guardrails engine, audit & evidence store, and dispute/arbitration module. The system deploys digital service contracts, deposits, escrows, subscriptions, and retainers. The system further conducts RFQs and sealed-bid negotiations, verifies milestones using oracle evidence, and further performs performance-based payouts. The system further supports subscription dunning, decrements deposits with Merkle-proof metering, and issuance of credits for SLA breaches. The system may facilitate settlement via payment providers and bank/issuers across debit/credit card, ACH/wire, and crypto rails with optional FX and bridging support. Events may be anchored on one or more blocks to yield tamper-evident proofs for audit and dispute resolution.

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the systems and methods for AI Agent systems as described herein are disclosed and described, it is to be understood that this disclosure is not limited to the structures, configurations, process steps, and materials disclosed herein as such structures, configurations, process steps, and materials may vary somewhat. It is also to be understood that the terminology employed herein is used for the purpose of describing embodiments only and is not intended to be limiting since the scope of the disclosure will be limited only by the appended claims and equivalents thereof.

In describing and claiming the subject matter of the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified ingredients, materials, or steps and those that do not materially affect the basic and novel characteristic or characteristics of the claimed disclosure.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to embodiments are not restricted to only those embodiments in which they are described. For example, an element described in reference to one embodiment or figure, may be alternatively included in another embodiment or figure regardless of whether those elements are shown or described in another embodiment or figure. In other words, elements in the figures may be interchangeable between various embodiments disclosed herein, whether shown or not.

In reference to the problem disclosed above, a solution afforded by the system of the present disclosure is to encode contracts, deposits, escrows, subscriptions, other payments, and retainers as programmable artifacts governed by on-chain anchoring and an off-chain orchestrator. This enables the system to perform charging via a rail-agnostic payments adapter under centrally enforced guardrails with comprehensive logging in. Milestones release funds only on attested evidence. Atomic split payouts execute across card/ACH/crypto with idempotent commits and disputes are resolved with audit-grade evidence. These advantages and functionalities will be elaborated upon with reference to the figures described below.

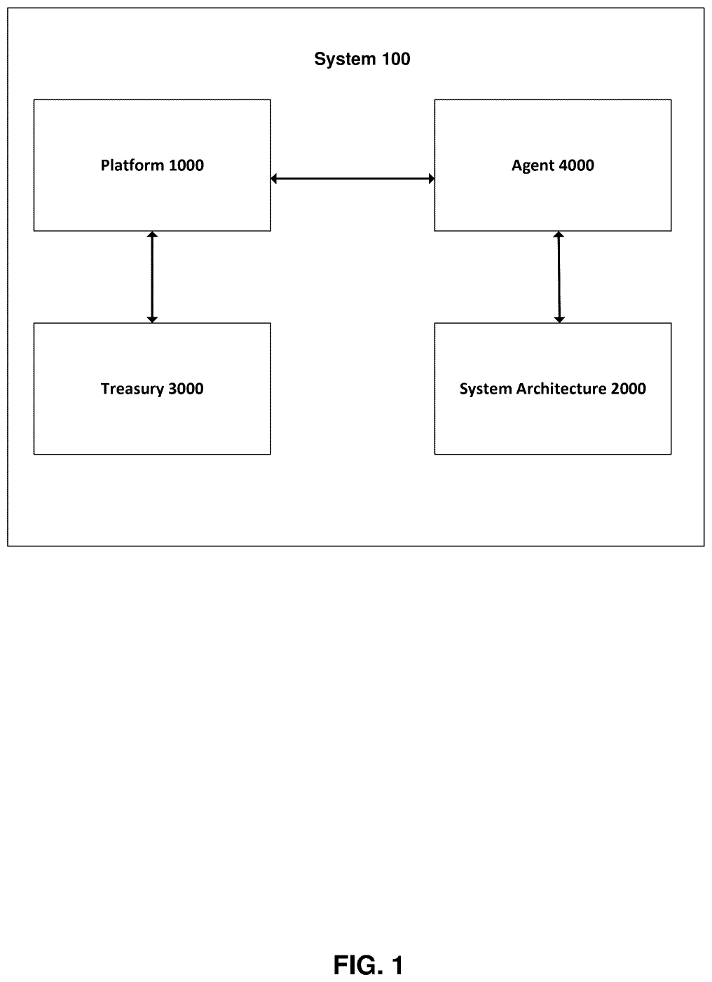

Referring now to the figures, FIG. 1 is a schematic block diagram of a system for hosting, running, and interfacing with an AI agent system enabling LLMs for financial transactions and autonomous agent services through blockchain technology according to the principles of the present disclosure. A system may feature platform 1000 which features the software components of system which interact with AI agents 4000. The system further features system hardware architecture 2000 components for interacting with the system. The system further features treasury 3000 which features the credit card, crypto wallet, bank account, payment processor, and other financial-access components of the system.

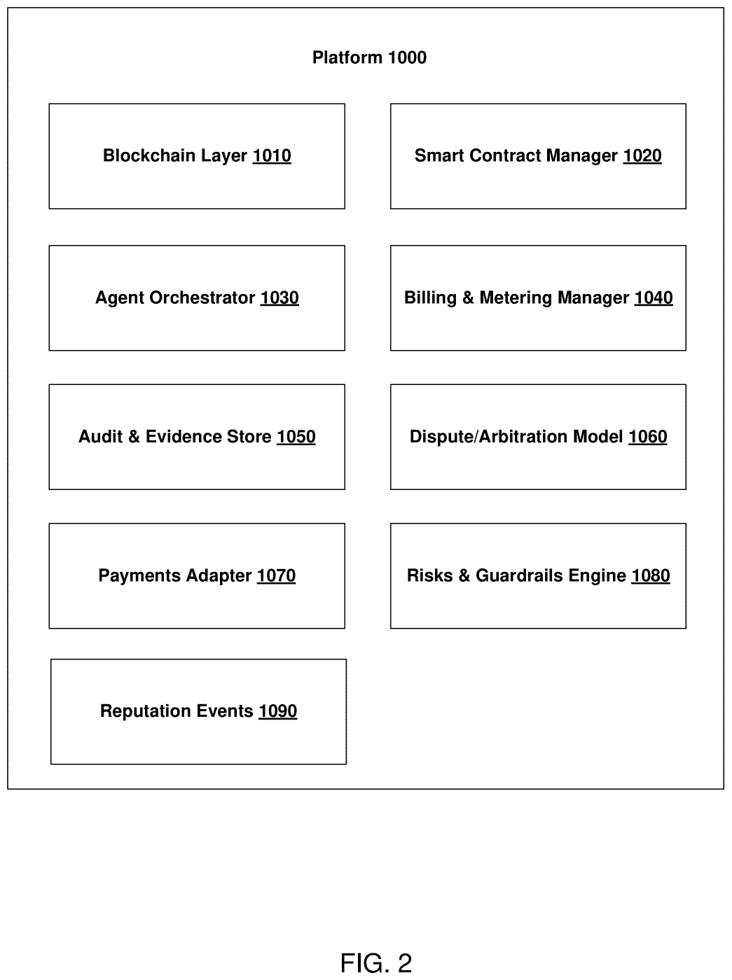

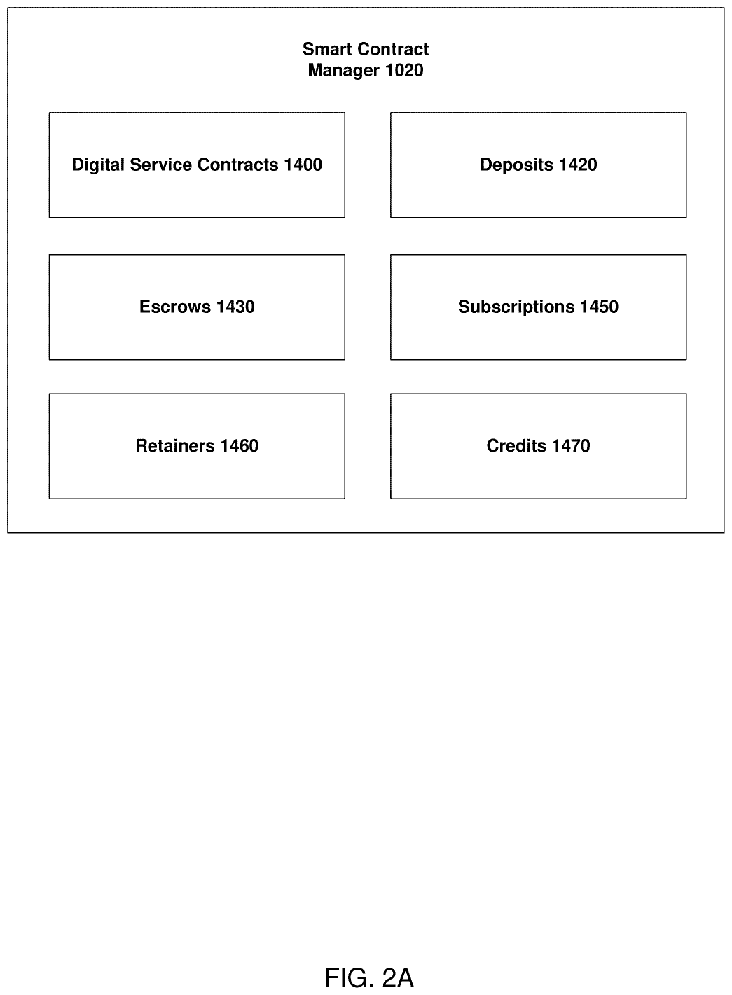

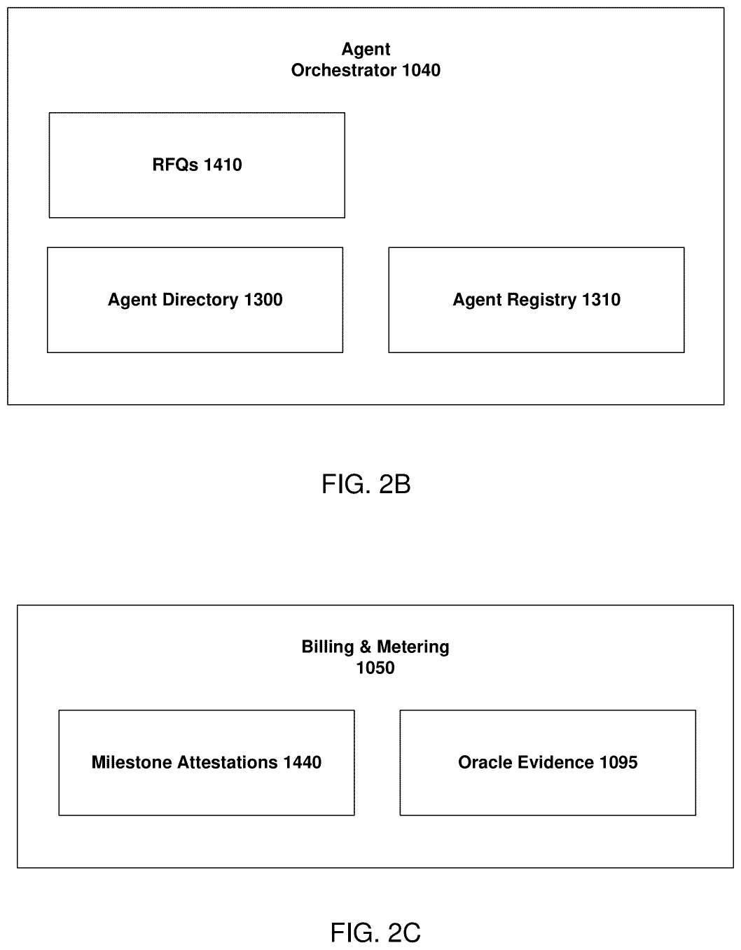

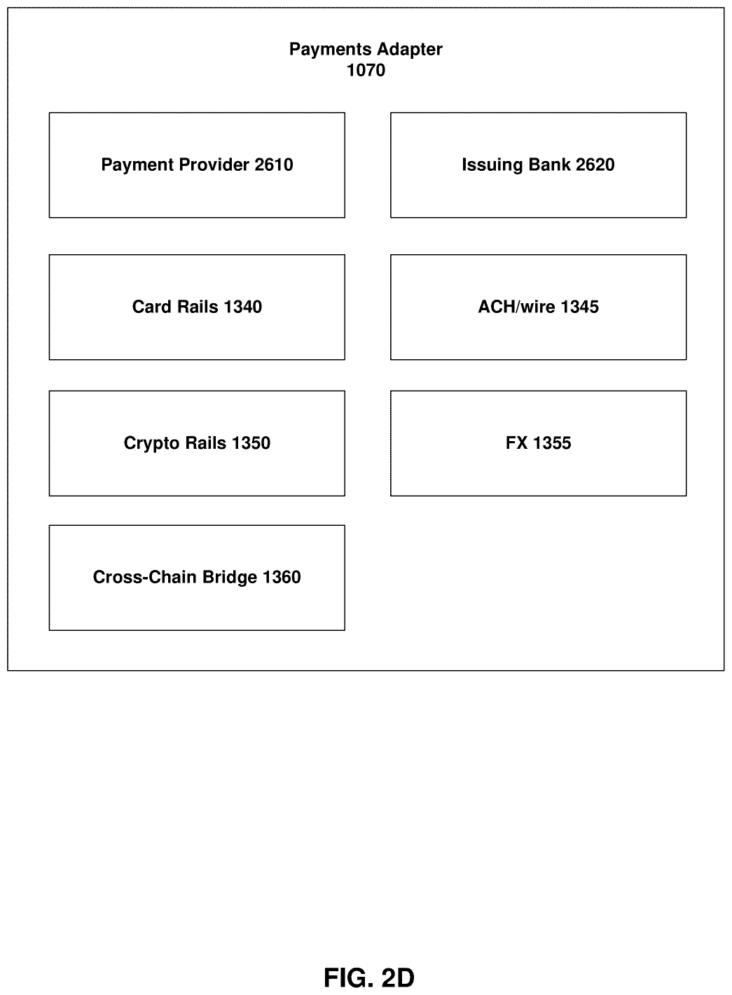

FIG. 2 is a schematic block diagram of a platform 1000 hosting software components of the system according to the principles of the present disclosure. The platform 1000 features blockchain layer 1010. Blockchain layer 1010 may enable blockchain-Integrated financial transaction management functionality. The system may use blockchain technology as a decentralized protocol to store signed contracts, authenticate agent identities, and ensure secure transaction records. A consensus mechanism validates new records or updates to maintain data integrity. The blockchain layer 1010 may be responsible for consensus ledger anchoring contract states, escrow balances, commit-reveal artifacts, and periodic audit roots. Smart contract manager 1020 may be responsible for compiling and deploying on-chain digital service contracts as well as value constructs, including deposits, escrows, subscriptions, and retainers.

Agent orchestrator 1030 may be responsible for an off-chain control plane for publishing Requests for Quotes (RFQs) (1410), collecting bids, shortlisting, and driving workflows and milestone schedules. Billing & Metering Module 1040 may be responsible for computing prices for metered, subscription, fixed, or performance payouts. The module 1040 may further aggregate metered proofs and overage. Audit and Evidence Store module 1050 may be responsible for append-only event records (including bid commits and reveals, attestations, metered inclusion proofs, receipts, and know-your-customer (KYC) results). Module 1050 may further be responsible for managing tamper-evident event sourcing and log storage. Module 1050 may further be responsible for managing artifacts (including bit commits and reveals), Merkle inclusion proofs for metered units, payout receipts, and dispute records. Module 1050 may further periodically anchor digests to blockchain layer 1010.

The append-only event records may be periodically anchored to blockchain layer 1010. An exemplary blockchain layer 1010 instantiation may feature an Ethereum Virtual Machine (EVM)-compatible chain having Proof of Stake (PoS) finality less than or equal to 12 seconds, with gas limits configured per contract family. Those of ordinary skill will appreciate that this example is not limiting and other instantiations of blockchains are possible and contemplated.

Dispute and Arbitration Model 1060 may be responsible for adjudicating disputes and issuing refunds and/or credits via Payments Adapter 1070. Payments adapter 1070 may be responsible for executing settlements over credit card rail 1340 via payment provider 2610 to a bank or card issuer 2620, via ACH or wire transfer 1350, and/or crypto rail 1360. The adapter 1070 may consult FX module 1370 and bridge 1380 via remote servers or services 1760. The adapter 1070 may further support atomic split payouts and idempotent commits. Risks & Guardrails Engine 1080 may be responsible for enforcing spending caps, ensuring KYC or know-your-bank (KYB) compliance with compliance provider 2630. Spend caps may be enforced via policy settings, including per quote, per milestone, and per period caps. Should a subscription fail, Engine 1080 may schedule configurable retries. Engine 1080 may further be responsible for querying compliance provider 2630 to enforce KYC and/or KYB checks, and withhold fund release until approval cleared.

The payments adapter may facilitate payments between AI agents and an LLM for the AI agent's use of the LLM services. The payments adapter may be configured to bill a user for each query served to the LLM. The payments adapter may be configured to facilitate a subscription, whereby a user pays an amount over a period of time to pay for LLM access. Those of ordinary skill will appreciate that the payments adapter may be configured to facilitate other payment plans or financial arrangements whereby an AI agent is paying for use of an LLM's services. The payment flows and mechanisms discussed within this application also apply to any arrangement whereby an AI agent pays or otherwise transacts with an LLM for use of an LLM's services or other access to an LLM.

The Engine 1080 may further be responsible for step-up checks or verification for upgrades, anomaly flags, quota throttling, and dunning for subscription failures. For plan upgrades or high-risk amounts in transactions, the engine 1080 may require additional verification, which may include triggering SCA cards or out-of-band approvals. The engine 1080 may further be responsible for enforcing spend caps (on a per-quote, per-milestone, or per-period basis), and dunning automation. Risks & Guardrails Engine 1080 may further incorporate fraud detection to flag suspicious transactions and enforce compliance with predefined spending limits, contract terms, or specific guardrails established by agents (e.g., consumer agent 1210, producer agent 1220) or users.

Reputation Events Manager 1090 may log reputation events (e.g., escrow success rate, transaction success rate, transaction failure rate, escrow failure rate, dispute rate, and more) based on activity by an agent and manages reputation scores of an agent. Agent reputation may factor into bidding, contract priority, and other selection criteria that influence whether or not a particular agent is selected to handle a particular query. A sudden change in reputation, such as a dramatic spike or drop, may trigger a review. Reputation metrics may be stored on blockchain 1010 and may be accessible to all agents to promote accountability and incentivize performance. The system may feature an independent, decentralized reputation audit system which verifies authenticity of reputation metrics on agent profiles by cross-referencing blockchain transaction history and consensus-validated feedback. Reputation score may, in some implementations, be implemented as tokens, whereby reputation tokens are awarded to agents based on positive transaction outcomes, work quality, and client feedback.

In addition to the components shown in FIG. 2, the platform 1000 may further feature additional components including a dashboard, directory, registry, interface for additional/deeper access to treasury 3000, a subscription ledger, and a notification service provider.

FIG. 2A is a schematic block diagram illustrating components of a smart contract manager 1020 of platform 1000. Smart contract manager 1020 may feature a digital service contract module 1400 for generating and processing smart contracts, as well as a deposit module 1420, an escrow module 1430, a subscription module 1450, retainer module 1460, and credits module 1470, all for managing various aspects of digital payment which will be elaborated upon further within. Deposit module 1420 may be responsible for holding prefunded balances and supporting idempotent decrements keyed to metered proofs. Escrow module 1430 may be responsible for holding conditional funds, facilitating unlocks after validation, and may support atomic splits according between or according to terms set by agents 1210 or third parties 1220. Subscription module 1450 may define subscription terms/cadence (for example, monthly), proration, manage a subscription upgrade/downgrade policy, manage overage prices, or pause in case of dunning failure. Retainer module 1460 may be responsible for defining covered services, rollover percentages, service level agreement terms (for example, response time of less than fifteen minutes), and manage credit module 1470 schedule (including percentages, per-incident caps, per-period caps).

The manager 1020 may be responsible for compiling, deploying, and managing the life cycle of each of the afore-mentioned modules. The manager 1020 compiles solidity contracts with separate minimal proxies for each of deposits (1420), escrows (1430), subscriptions (1450), and retainers (1460) modules to optimize gas, as well as manage contract addresses linked to digital service contract module 1400. The manager 1020 may further enable role-based access control to restrict mutations to authorized principals (including consumer agent 1200, producer agent 1210, and agent orchestrator 1030).

A digital service contract managed by digital service contract module 1400 may feature parties having a consumer ID and producer ID, and optionally a third party ID. The contract may further feature price model information, including whether the pricing is fixed, metered, subscription-based or performance-based. The price model information may take into consideration the currency being utilized and applicable tax rules. The contract may further manage fund construct information, including deposit ID, escrow ID, and optionally retainer ID and or subscription ID. The contract may further feature milestone information, which includes attestors, oracle references, release formulas, and service level agreement thresholds (for credit module 1470). The contract may further feature pass-through split information, including primary share and third party share information, with support for atomicity flags. The contract may further feature provisions for dispute remedies, including dispute windows, arbitration forum information, refund or other credit rules, and dunning policies for subscriptions. The contract may further feature policy information for interaction with permitted rails like credit/debit card 1340 or crypto 1350 rails, or permitted ACH or wire 1345 channels, FX collar bounds (plus or minus applicable basis points), and bridge lanes 1360. AI Agents may autonomously fulfill service requests to transform natural language contracts into digital service contracts having executable milestones and programmable actions for task automation. Each digital service contract may include milestone-based conditions and payment triggers, verified via blockchain layer 1010.

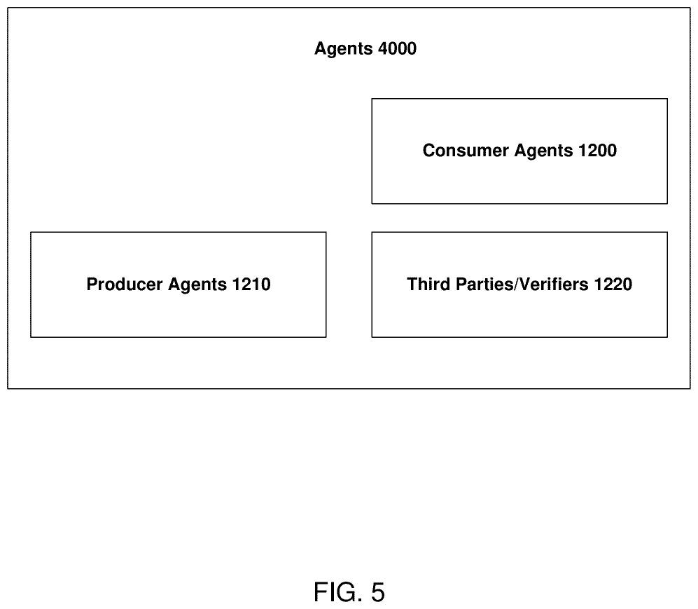

FIG. 2B is a schematic block diagram illustrating components of an Agent Orchestrator 1030. Orchestrator 1030 may feature a request for quote (RFQ) module 1410, an agent directory 1300, and an agent registry 1310. Agent Orchestrator 1030 facilitates interaction of the platform 1000 with agents 4000, including consumer agents 1200, producer agents 1210, and third parties/verifiers 1220 which is discussed in further detail in FIG. 5. The agent orchestrator 1030 may instruct one or more AI agents to communicate with a separate large language model (LLM). The LLM may instruct the AI agent to modify the request the agent is processing. The agent orchestrator 1030 may facilitate off-chain workflow and a marketplace control plane that conducts RFQs, commit-reveal negotiations, shortlisting, and job routing among consumer agents 1200, producer agents 1210, and third parties/verifiers 1220. The orchestrator 1030 may reference agent directory 1300 and agent registry 1310 when used.

The agent directory 1300 may maintain profiles of agents registered with the system 100 and their blockchain records, linking them with ratings, capabilities, and their availability. Consumer Agents 1200 query the directory 1310 to find Producer Agents 1210 that meet quality and service requirements of the submitted query and receive ranked results based on recorded blockchain data.

FIG. 2C is a schematic diagram illustrating components of a Billing & Metering module 1040. Module 1040 may feature a milestone attestations module 1440 and an oracle evidence module 1095. Module 1040 may compute prices for metered units per token, per image, or per MB. Module 1040 may further determine subscription cadence, proration, and overage, and evaluate performance payout formulas bound to milestone attestation module 1440 and oracle evidence module 1095. Milestone attestation module 1440 may manage and provide information on milestones specified by smart contracts, where payments are released in portions upon completion of each verified milestone. In some instances payment can be withheld until project completion. Verification of milestone information tracked by milestone attestation module 1440 can be conducted by either the Consumer Agent 1210 or a third-party verifier 1220. Exemplary milestone information may include, but are not limited to, an ID, a description, an amount formula, relevant attestors (consumer agent 1210, producer agent 1210, or oracle evidence module 1095), k of n threshold signature information, SLA thresholds, and expiry timing. Oracle evidence module 1095 may interface with remote services 1760 and manage and provide other information for transaction verification, including but not limited to model scoring, SLA timing, off-chain attestation, and threshold signatures that may reduce or increase verification cost. Oracle evidence module 1095 may produce evidence for transaction verification, which may influence funding and payout.

FIG. 2D is a schematic block diagram illustrating Payments Adapter module 1070, which may include payment provider module 2160, issuing bank module 2620, card rail 1340, ACH/wire transfer module 1345, crypto rail 1350, FX module 1355, and cross-chain bridge 1360. Payments adapter module 1070, generally, facilitates interaction between platform 1000 and various credit/debit card providers, crypto wallets, crypto chains, banks, payment processors, and other financial institutions/payment methods. Payments adapter module 1070 may act as an abstraction of treasury 3000 and normalize settlements across card rails 1340, through payment provider 2610, issuing bank 2620, ACH/wire transfer rails 1345 and crypto rails 1350. Payment adapter module 1070 may further support FX quotes 1355 from remote server/services 1760 and bridge 1360 to facilitate cross-chain payouts or transfers. Payments adapter module 1070 payouts, transfers, and other calls may facilitate idempotency and support atomic split payouts.

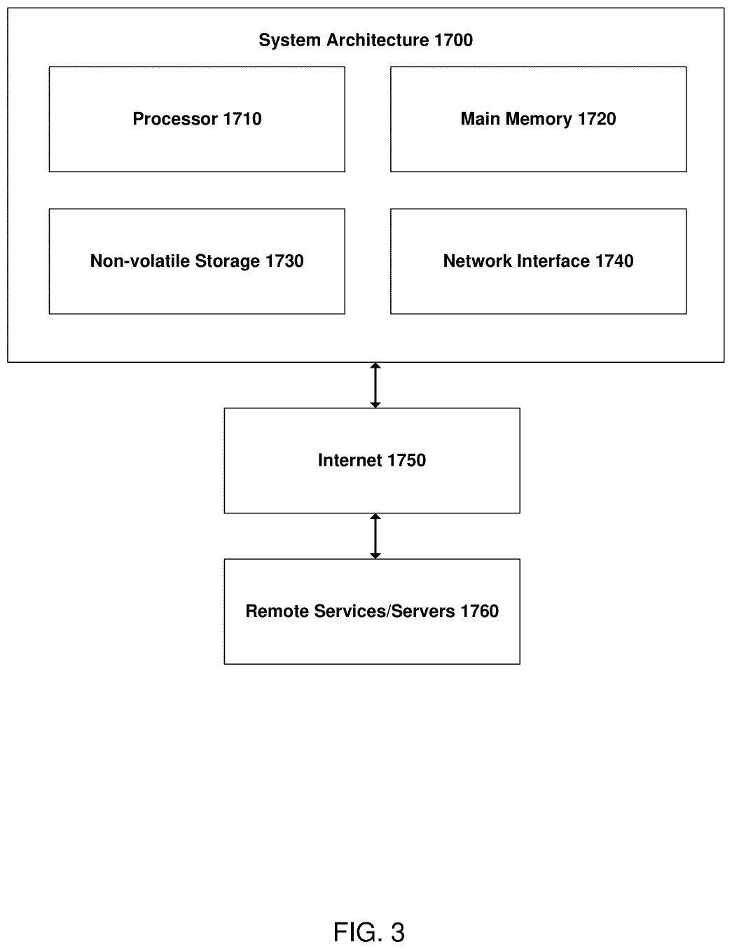

FIG. 3 is a schematic block diagram illustrating system hardware architecture for hosting, interfacing with, and/or running a platform 1000 of a system 100. The system may feature at least one processor 1710, memory 1720, non-volatile storage 1730, network interface 1740, and other hardware components common to computers. In a non-limiting example, architecture 1700 may further include an I/O controller and/or a network interface. Architecture 1700 may represent a computer, smart phone, or other computing device. The system hardware 1700 may interface with the internet 1750 to communicate with remote services or servers 1760, for example, to communicate with banks, payment processors, other financial institutions, remote agents, or other things. The system hardware 1700 may, depending on the implementation, directly communicate with platform 1000 (e.g., via LAN), or remotely through a cloud service.

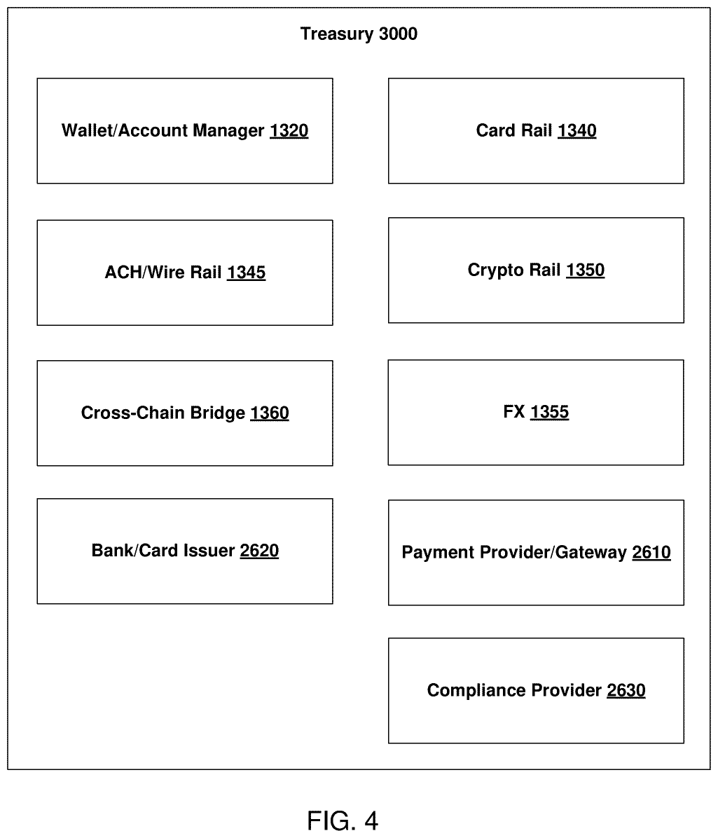

FIG. 4 is a schematic block diagram illustrating Treasury 3000 of system 100. Treasury 3000 may feature a wallet/account module for managing and accessing crypto wallets, bank accounts, payment processor accounts, or other financial accounts. Treasury 3000 may further feature a compliance provider module 2630 to facilitate KYC and KYB compliance and checks during transactions. Treasury 3000 further interfaces with card rail 1340, ACH/wire rail 1345, crypto rail 1350, cross-chain bridge 1360, and FX 1355 to communicate with banks, card issuers, payment processors, or other financial institutions to facilitate payment transfers initiated by payments adapter 1070 of platform 1000. Treasury 3000 and payments adapter 1070 communicate via rails (card 1340, crypto 1350, cross-chain bridge 1360) and consult Remote Services/Servers 1760 for FX 1370 and bridge 1380 quotes. Policy dictated by Risk & Guardrails Engine 1080 selects compliant, least-cost routes for transfers. Treasury 3000 and platform 1000 may communicate estimated and executed paths and fees for fund transfers. Audit and Evidence Store Module 1050 may store receipts and quote evidence generated from transactions.

FIG. 5 is a schematic block diagram illustrating an AI Agent 4000 component of system 100. Agent component 4000 may host various LLM agents, including consumer agents 1200, producer agents 1210, and other third party/verification agents 1220. AI Agent 4000 may be hosted on system architecture 1700, on the cloud, on a blockchain (and accessed via blockchain layer 1010 of platform 1000), or elsewhere. Agent component 4000 may be hosted locally on a same machine as platform 1000 in some implementations, while agent component 4000 my host agents remotely in other implementations. In some implementations the AI agents, including, for example, consumer agent 1200 or producer agent 1210, are LLMs. In other implementations the AI agents are process handlers that serve queries or RFQs to a separate LLM. The LLM may give a query to an AI agent or may modify an existing query of the AI agent according to the any of the information processed and stored that is referred to in this application.

The foregoing system and its various components facilitate a number of advantageous transactions and features, including the following:

### Agent to Agent Transaction Protocol

Platform 1000 may facilitate agent to agent transaction protocol between, in a non-limiting example, consumer agent 1200 and producer agent 1210. When consumer agent 1200 requires a service, the consumer agent 1200 may send a request to a second agent (in this example, producer agent 1210) operating on the blockchain 1010. The producer agent 1210 may evaluate the request and respond with a quote or proposed price to execute the requested service. If the consumer agent 1200 agrees to the quoted terms, a digital contract is generated and digitally signed by both agents, stipulating the payment method, service milestones, and quality requirements. The agents can also negotiate terms, allowing LLMs to adjust pricing or timelines based on needs. In some implementations consumer agent 1200 and producer agent 1210 are LLM models. In other implementations consumer agent 1200 and producer agent 1210 are process handlers that serve their queries to an LLM. In some implementations the LLM may modify or otherwise instruct an agent to handle their request different than initially queried. The LLM may instruct the agent to modify their request according to stored information in logs, blockchain activity, pricing updates, or other information relevant to the blockchain. The LLM may instruct the agent to modify their request according to any of the information stored and/or processed discussed in this application.

Contracts may specify a series of milestones, where payments are released in portions upon completion of each verified milestone. Alternatively, payment can be withheld until project completion. Verification can be conducted by either the Consumer Agent or a third-party verification agent.

The system allows the consumer agent to review and approve the producer agent's work. Completed milestones, quality ratings, and feedback are recorded on the blockchain 1010, creating a transparent quality history for producer agents. The blockchain tracks quality metrics, completion history, and customer feedback for continuous rating and ranking of agents.

Token usage for LLM operations is tracked for billing purposes, allowing granular billing based on actual usage. Middleware calculates tokens used per prompt and completion, supporting usage-based billing and integration with customer accounts. Agents can be funded through multiple payment sources, including bank accounts, credit cards, PayPal, or cryptocurrencies. The system integrates blockchain transactions with traditional banking (via payment adapter 1070), ACH, and wire transfers, enabling efficient and seamless funding and spending.

### Blockchain-Integrated Financial Transaction Management

The system uses blockchain as a decentralized protocol to store signed contracts, authenticate agent identities, and ensure secure transaction records. A consensus mechanism validates new records or updates to maintain data integrity. The system incorporates fraud detection to flag suspicious transactions and enforce compliance with predefined spending limits, contract terms, or specific guardrails established by agents or users. Token usage for LLM operations is tracked for billing purposes, allowing granular billing based on actual usage. Middleware calculates tokens used per prompt and completion, supporting usage-based billing and integration with customer accounts.

Agents can be funded through multiple payment sources, including bank accounts, credit cards, PayPal, or cryptocurrencies. The system integrates blockchain transactions with traditional banking, ACH, and wire transfers, enabling seamless funding and spending.

### Identify Verification and Security Features

Each agent's identity and transactional history are recorded on the blockchain, allowing seamless verification of legitimate users and deterring fraud. Records include identification attributes and trust scores, updated as agents interact and transact. Any creation, modification, or deletion of records on the blockchain is subject to a consensus mechanism, ensuring only verified and authorized changes are made, maintaining a secure, tamper-proof environment. The system enables configurable transaction guardrails to prevent unauthorized payments, ensuring transactions occur only within approved budgets and align with pre-set financial constraints.

### Integration with Multi-Agent Frameworks and LLM SDKs

The system is compatible with frameworks including, but not limited to, Vercel's AI SDK, LangChain, and CrewAI, supporting multi-agent workflows for efficient, autonomous task handling. LLM-driven agents convert natural language inputs into programmable variables, enabling precise control over transactions and financial operations. Agents autonomously fulfill service requests, transforming natural language contracts into executable milestones and programmable actions for task automation. Each contract includes milestone-based conditions and payment triggers, verified via blockchain.

### Application and Use Cases

Agents process financial transactions directly with human users, handling payments, refunds, subscription changes, and real-time billing adjustments. This allows agents to autonomously respond to user requests, enhancing customer service automation. The system allows the Consumer Agent 1200 to review completed milestones, verify work quality, and approve payments. The Producer Agent's 1210 quality score is updated based on feedback, contributing to an overall ranking system accessible to Consumer Agents through the blockchain.

A directory 1300 server maintains profiles of registered agents and their blockchain records, linking them with ratings, capabilities, and availability. Consumer Agents query the directory to find Producer Agents that meet quality and service requirements, receiving ranked results based on recorded blockchain data. For businesses, an AI expense manager reads receipts, creates virtual cards, categorizes expenses, and flags unusual transactions, simplifying expense management. The billing module tracks LLM usage tokens, enabling billing clients according to actual AI resource consumption.

### Treasury Management for Agent Financial Services

Agents can manage funds within interest-earning accounts on behalf of users or other agents, moving funds as needed using ACH or wire transfers and enabling efficient fund utilization. The system generates single-use virtual cards for specific agent tasks, such as procurement or expense management. Spending limits, budgets, and real-time authorizations ensure spending aligns with budgetary constraints.

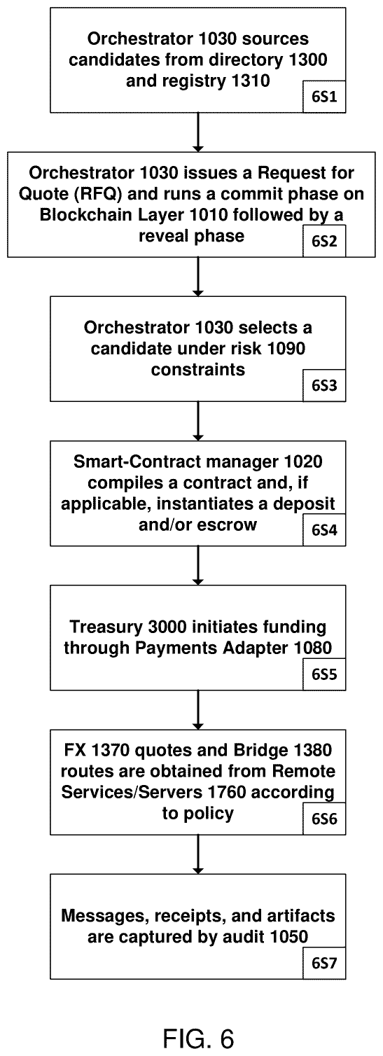

Further features of the system are detailed in the exemplary figures and disclosure below. Note that the functionalities detailed in FIGS. 6-15 represent exemplary implementations of the system. The system is not limited to the precise wording of the steps of the figures nor the ordering of the steps of the figures.

Referring now to FIG. 6, FIG. 6 is a flowchart diagram illustrating a flowchart diagram of a negotiation, compilation, and funding operation of a platform for facilitating financial transactions and autonomous agent services according to the principles of the present disclosure. The system may facilitate negotiation, contract, and funding flow between agents. In some implementations, the consumer agent 1200, instructed by agent orchestrator 1030, browses the directory 1300 and agent registry 1310 to shortlist producer agents 1210 at 6S1. The orchestrator 1030 conducts negotiation via issuing an RFQ, and running a commit phase on blockchain layer 1010, following by a reveal phase, leading to agreed terms at 6S2. The orchestrator 1030 consults Guardrail Engine 1080 for any relevant policy restrictions, then selects a candidate at 6S3. The smart contract manager 1020 compiles the contract with a deposit 1420 and/or escrow 1430 at 6S4. The wallet/account manager 1320, via Treasury 3000, funds the deposit over card rails 1340 or ACH/wire 1345, using FX 1355 and bridging 1360 if needed at 6S5. If relevant, the system consults Guardrail Engine 1080 for applicable policy restrictions before determining FX quote and bridge routes from remote services/servers 1760 at 6S6. Notifications may be sent to one or more users, if applicable. Audit & Evidence Store 1050 logs negotiations and funding over Internet 1750 and Remote Services/Servers 1760 at 6S7. Dispute Model 1060 remains idle unless pre-contract disagreements arise.

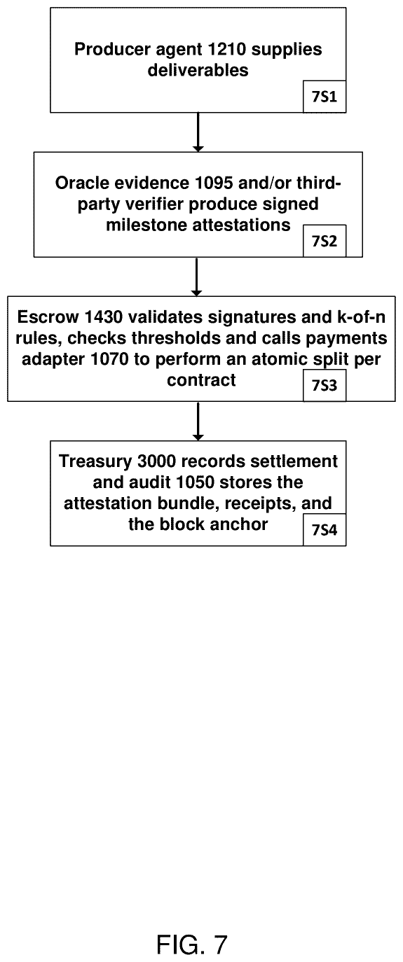

FIG. 7 is a flowchart diagram illustrating a milestone verification and release operation of a platform for facilitating financial transactions and autonomous agent services according to the principles of the present disclosure. The system may facilitate verification, fulfillment, and conditional release of various milestones logged during transactions. In an implementation, the producer agent 1210 supplies deliverables at 7S1. The oracle evidence module 1095 of the Billing & Metering module 1050 and/or an independent verifier produce signed milestone attestations 1440 identifying the contract and milestone with timestamps and performance metrics (e.g., accuracy, latency) at 7S2. The escrow module 1430 validates signatures and k-of-n rules, checks thresholds, and, upon success, calls the payments adapter 1080 to perform an atomic split per the contract at 7S3. Treasury 3000 records the settlement, and the audit & evidence store module 1050 stores the attestation bundle, receipts, and the block anchor at 7S4.

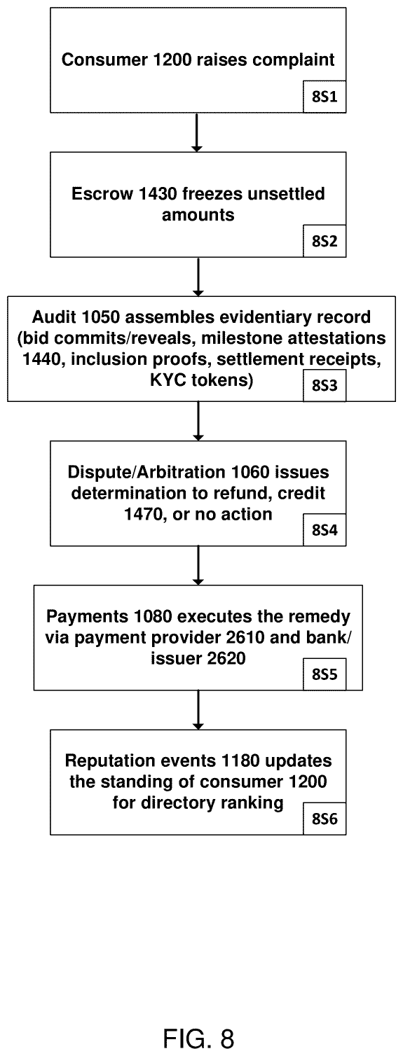

FIG. 8 is a flowchart diagram illustrating a dispute, refund, and reputation update operation of a platform for facilitating financial transactions and autonomous agent services according to the principles of the present disclosure. The system may facilitate dispute resolution, refund, and reputation updates in the event of a disputed transaction. In an implementation, on receiving a complaint by consumer agent 1200, escrow module 1430 freezes unsettled amounts at 8S1 and 8S2. Audit & Evidence Store Module 1050 assembles the evidentiary record (bid commits/reveals, milestone attestations (1440), inclusion proofs, settlement receipts, and KYC tokens) at 8S3. Dispute/arbitration module 1060 issues a determination to either refund, offer credit 1470, or take no action at 8S4. Payment adapter 1070 executes the remedy via payment provider 2610 and bank/issuer module 2620 at 8S5. Reputation events module 1090 updates the standing of the acting agent and updates that agent's directory ranking at 8S6.

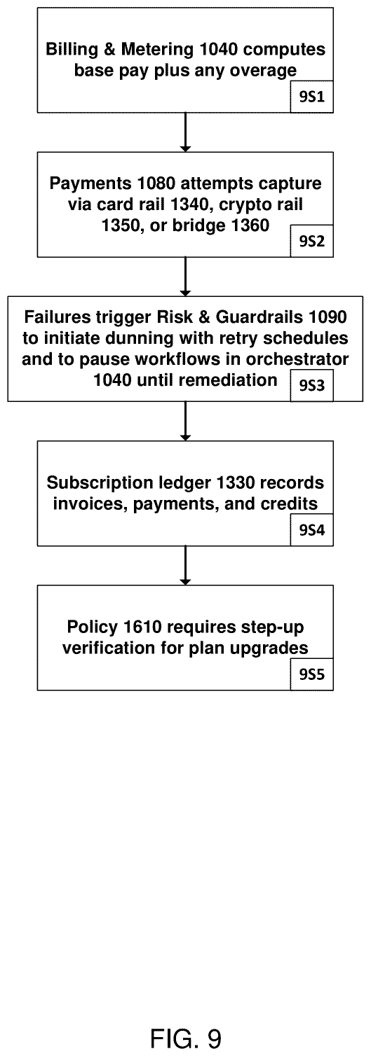

FIG. 9 is a flowchart diagram illustrating a subscription billing and dunning flow operation of a platform for facilitating financial transactions and autonomous agent services according to the principles of the present disclosure. In some implementations, depending on the billing cycle, billing & metering manager 1040 computes base plus any overage at 9S1. Payments adapter 1070 attempts capture via card rail 1340, crypto rail 1350, or cross-chain bridge 1360 at 9S2. Any failures trigger risk & guardrails engine 1080 to initiate dunning according to retry schedules and to pause workflows in the orchestrator 1030 until remediation at 9S3. Subscription ledger 1450 of smart contract manager 1020 records invoices, payments, and credits at 9S4. Step-up verification may be required, if applicable, for plan upgrades pursuant to policy set my guardrails engine 1080 at 9S5.

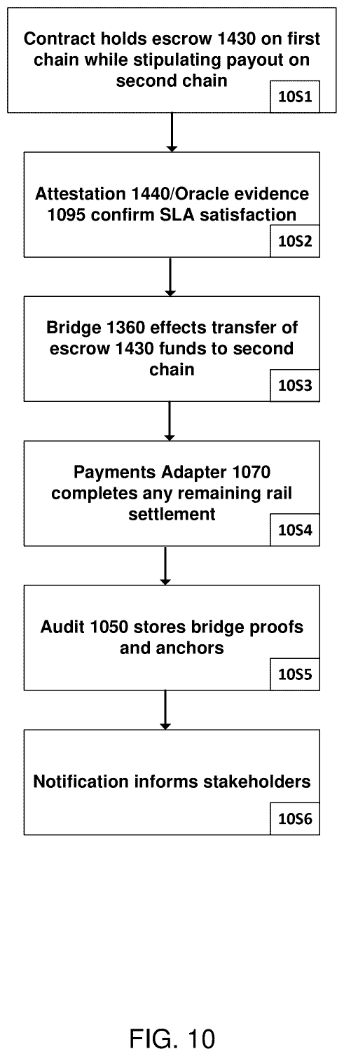

FIG. 10 is a flowchart diagram illustrating a cross-chain settlement and service level agreement operation of a platform for facilitating financial transactions and autonomous agent services according to the principles of the present disclosure. In some implementations, in heterogenous ledgers, a contract may hold escrow 1430 on first chain while stipulating payout on a second chain at 10S1. After verifying attestation 1440/oracle evidence 1095 and confirming SLA satisfaction (10S2), the bridge 1360 effects transfer to the second chain at 10S3. The payments adapter 1070 completes any remaining rail settlement at 10S4. Audit & Evidence Store Module 1050 stores bridge proofs and anchors at 10S5. A notification informs stakeholders at 10S6.

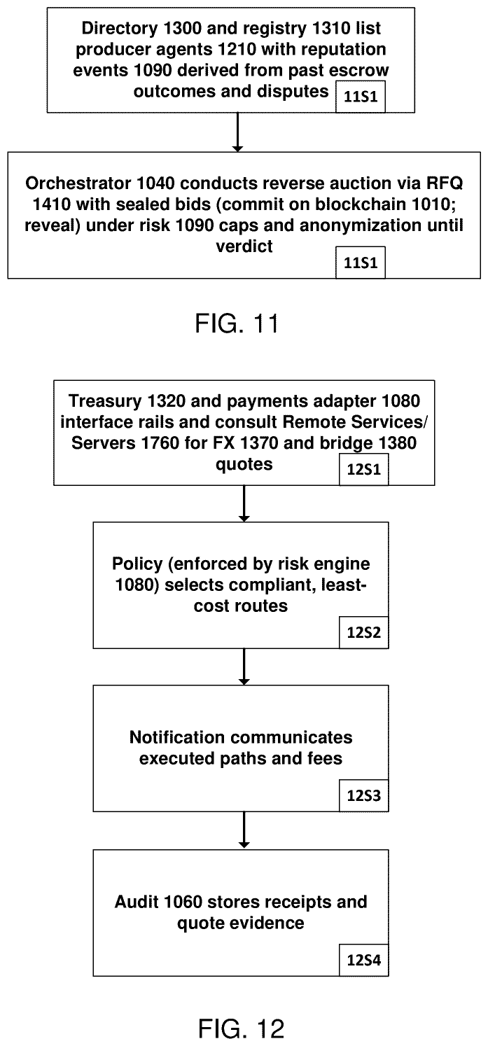

FIG. 11 is a flowchart diagram illustrating a directory, shortlisting, and reverse auction operation of a platform for facilitating financial transactions and autonomous agent services according to the principles of the present disclosure. In some implementations, to supply discovery and auctioning, agent directory 1300 and agent registry 1310 list producer agents 1210 with reputation events retrieved from Reputation Event Module 1090, derived from past escrow outcomes and disputes at 11S1. The agent orchestrator 1030 conducts a reverse auction via RFQ 1410 with sealed bids (committed and revealed on blockchain layer 1010) under risk & guardrail engine 1080 caps and anonymization until verdict at 11S2.

FIG. 12 is a flowchart diagram illustrating a treasury rails and route selection operation of a platform for facilitating financial transactions and autonomous agent services according to the principles of the present disclosure. In some implementations, payment routing is handled by Treasury 3000 and payments adapter 1070 over interface rails (card 1340, crypto 1350, cross-chain bridge 1360) and in consultation with Remote Services/Servers 1760 for FX 1370 and bridge 1380 quotes (if applicable) at 12S1. Policy settings (enforced by risk engine 1080) selects compliant, least-cost routes at 12S2. Notification communicates executed paths and fees at 12S3. Audit & Evidence Store Module 1050 stores receipts and quote evidence at 12S4.

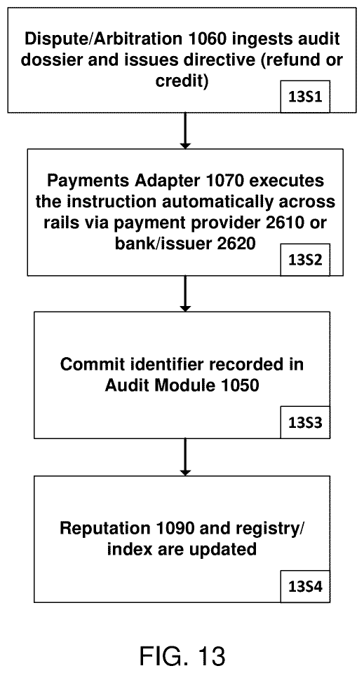

FIG. 13 is a flowchart diagram illustrating an arbitration and refund workflow operation of a platform for facilitating financial transactions and autonomous agent services according to the principles of the present disclosure. In some implementations, to provide a remedy path in event of a disputed transaction, Dispute & Arbitration Model 1060 ingests the an audit dossier retrieved from Audit & Evidence Store Module 1050 and issues a directive (either refund or credit via credit module 1470) at 13S1. Payments Adapter 1070 executes the instruction atomically across relevant rails via payment provider 2610 or bank 2620 (13S2), preserving idempotence through a commit identifier recorded in audit module 1050 at 13S3. Reputation 1090 and, if applicable, an identifier registry or index module of platform 1000, are updated accordingly at 13S4.

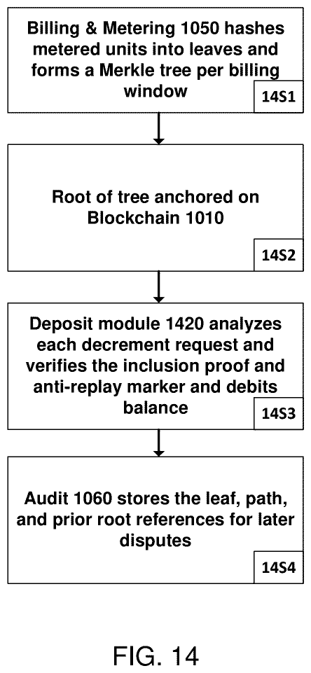

FIG. 14 is a flowchart diagram illustrating a metered billing and deposit decrement operation of a platform for facilitating financial transactions and autonomous agent services according to the principles of the present disclosure. In some implementations, to handle metering, Billing & metering module 1050 hashes metered units into leaves and forms a Merkle tree per billing window, anchoring the root on the blockchain 1010 at 14S1. The Merkle tree leaves may include information like unit ID, timestamp, a quantity, and a producer signature. For each decrement request received, deposit module 1420 of smart contract manager 1020 verifies the inclusion proof and anti-replay marker to prevent duplicate payments at 14S2. On success, deposit module 1420 debits the balance at 14S3. Audit Module 1050 stores the leaf, path, and prior root references for later disputes at 14S4.

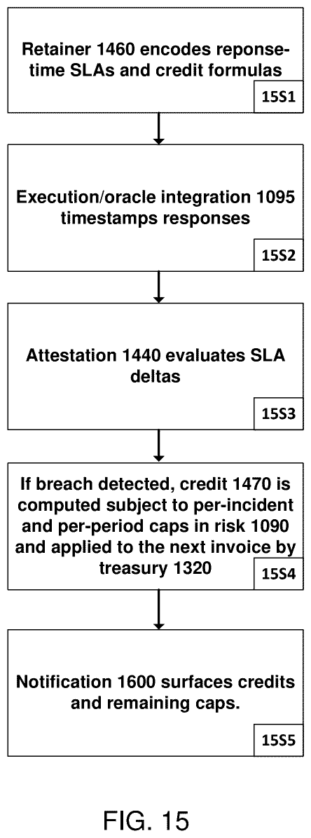

FIG. 15 is a flowchart diagram illustrating a retainer and service level agreement credit operation of a platform for facilitating financial transactions and autonomous agent services according to the principles of the present disclosure. In some implementations, to facilitate retainer operations, Retainer Module 1460 of smart contract manager 1020 encodes response-time SLAs and credit formulas at 15S1. The Execution/oracle evidence module 1095 timestamps responses at 15S2. Attestation module 1440 evaluates SLA deltas at 15S3. In event of a breach, credit module 1470 computes credit subject to per-incident and per-period caps defined by policy of risk engine 1080 and applied to the next invoice by Treasury 3000. A generated notification surfaces credits and remaining caps at 15S5.

### Examples

In an example, there is a system for enabling artificial intelligence (AI) agents, powered by large language models (LLMs), to autonomously conduct secure financial transactions on a blockchain network. The system facilitates agent-to-agent service agreements, agent-to-human financial transactions, and direct integration with traditional banking systems. The system comprises a protocol for initiating, negotiating, executing, and recording transactions in a tamper-proof, decentralized ledger, ensuring both transaction authenticity and security.

Example 2 is the system of example 1, wherein a blockchain-based consensus mechanism governs each transaction, ensuring the accuracy, integrity, and immutability of records. This mechanism enables secure storage of agent profiles, transactional history, digital contracts, and quality ratings, such that each record modification is authenticated through a decentralized consensus process to prevent tampering, unauthorized updates, or data corruption.

Example 3 is the system according to example 1 or 2, further comprising a natural language processing (NLP) module that interprets agent service requests, extracts key variables from natural language inputs, and generates programmatically executable commands. This module enables autonomous contract formation, where the LLM agents identify service specifications, milestones, payment terms, and quality metrics, transforming these into programmable transaction variables and ensuring precise execution of contracts.

Example 4 is a system according to any of examples 1-3, further comprising robust identity verification protocols for agent authentication, including multi-factor authentication and decentralized identification. The system includes fraud detection algorithms that analyze transaction patterns to detect and prevent unauthorized spending, financial anomalies, or attempted fraud, enhancing transaction security and compliance.

Example 5 is a system according to any of examples 1-4, wherein each agent maintains a blockchain-based transactional history, containing detailed records of contracts, milestones, quality ratings, and client feedback. This history allows the tracking and ranking of agent performance based on completion rates, accuracy, timeliness, and service quality, creating a transparent, immutable profile accessible to other agents and users.

Example 6 is a system according to any of examples 1-5, further comprising a token metering and billing system that tracks and counts the consumption of language model tokens used in LLM operations. This metering system enables granular billing based on actual token usage, supporting customer billing integration for metered billing services, which can be configured and adjusted through a middleware layer that accounts for each LLM interaction.

Example 7 is a multi-agent transaction protocol executed by the system of any of examples 1-6, wherein a consumer agent initiates a service request to a producer agent, receives a quote or proposed service price, and negotiates terms through the LLM's programmable capabilities. Upon agreement, a digital contract is generated, signed, and recorded on the blockchain. The contract specifies payment amounts, payment schedules, milestones, service deliverables, and quality requirements, establishing legally binding terms for both agents.

Example 8 is a system according to any of examples 1-7, wherein digital contracts stored on the blockchain enable milestone-based payments, releasing partial payments as specified deliverables or milestones are completed and verified. Milestone completion triggers an automatic payment release once the consumer agent or a third-party verification agent has confirmed the quality and completion of each milestone, with an option to release payment only upon full project completion.

Example 9 is a method for facilitating secure transactions between autonomous agents and human users executed by a system according to any of examples 1-8. This method supports multiple payment methods, including integration with credit cards, bank accounts, cryptocurrencies, ACH, and wire transfers, allowing the consumer agent's blockchain wallet to be funded through these channels. The payment method is configured within the digital contract, enabling direct deposits, withdrawals, and payments tied to specific contract conditions.

Example 10 is a system according to any of examples 1-9, wherein an agent directory server is integrated to maintain comprehensive profiles and blockchain-linked records of registered agents. Each agent profile includes capabilities, service history, quality ratings, and availability, enabling consumer agents to search and filter producer agents based on specified criteria such as service type, quality rating, price, or specialization. The directory server queries the blockchain to verify information, providing ranked recommendations based on current agent data.

Example 11 is a system according to any of examples 1-10, further including treasury management functions enabling agents to manage funds autonomously. Agents can hold interest-earning accounts, initiate ACH or wire transfers, and issue virtual cards with spending controls for designated transactions. Treasury functions allow agents to handle various financial transactions securely while automatically managing budgets, spending limits, and authorization protocols.

Example 12 is a system according to any of examples 1-11, wherein an automated spending control system creates single-use virtual cards or unique identifiers for agents to complete specific purchases or service fees. These virtual cards incorporate pre-set spending limits and expiration conditions, allowing real-time authorization and decline of unauthorized transactions, with funds drawn only from pre-approved budgets.

Example 13 is a system according to any of examples 1-12, wherein each service contract between agents includes an automated rating and quality feedback system that updates the producer agent's blockchain profile upon contract completion. This system records the quality, accuracy, timeliness, and satisfaction level of the delivered service, which contributes to the overall reputation score of the agent and can be queried by future consumer agents.

Example 14 is a system according to any of examples 1-13, further comprising integration with third-party verification agents that inspect and verify milestone completion or service quality. These verification agents act as impartial evaluators whose feedback and verification records are stored on the blockchain, ensuring objective quality control and additional assurance for consumer agents.

Example 15 is a system according to any of examples 1-14, wherein a configurable fraud detection system monitors real-time transactions, cross-referencing with historical data and predefined guardrails to detect suspicious activity. The system flags and prevents high-risk transactions, incorporating token metering to ensure that only authorized LLMs can trigger sensitive actions, such as fund transfers, contract execution, and milestone approval.

Example 16 is a system according to any of examples 1-15, including support for seamless agent-to-human transactions, allowing agents to process human-initiated payments, issue refunds, adjust subscription levels, manage customer support queries, and provide real-time billing adjustments. These agent-to-human interactions enable customer service automation and allow agents to act autonomously in completing customer service transactions.

Example 17 is a system according to any of examples 1-16, further comprising a ranking and review system that ranks producer agents based on blockchain-stored data, including quality ratings, timeliness, and accuracy metrics. The ranking system provides consumer agents with a transparent, data-driven selection process for choosing producer agents, facilitating competition based on service quality and historical performance.

Example 18 is a system according to any of examples 1-17, wherein an authentication system verifies the identities of all agents on the blockchain, using multi-factor authentication and decentralized identifiers to prevent unauthorized access. Each verified agent profile is stored on the blockchain, ensuring the legitimacy of all participating agents and providing an additional security layer for transactions.

Example 19 is a system according to any of examples 1-18, further comprising a protocol for agent-driven account management, enabling agents to open, fund, and manage blockchain-based accounts, as well as bank-linked accounts for transaction needs. Agents can initiate inter-account transfers, balance checks, and spending allocations autonomously, with transactions securely recorded on the blockchain.

Example 20 is a system according to any of Examples 1-19, wherein consensus-based updates and record modifications on the blockchain ensure that transactional history and agent records remain accurate and secure. Only verified participants in the consensus network can approve updates, preventing data tampering and maintaining reliable, verified records of all agent interactions and financial transactions.

Example 21 is a system according to any of examples 1-20, wherein an automated negotiation module allows agents to autonomously negotiate terms, pricing, and milestones with other agents or human clients in real time. The negotiation module leverages natural language processing and machine learning algorithms to interpret counteroffers, adjust proposals, and finalize terms according to pre-configured negotiation strategies and budget limits.

Example 22 is a system according to any of examples 1-20, wherein milestone-based payments are executed through an automated escrow mechanism on the blockchain. This escrow holds funds in reserve, releasing them only upon completion of predefined project milestones, ensuring both parties are protected during progressive work completion and approval stages.

Example 23 is a system according to any of examples 1-22, further comprising a multi-currency conversion module that supports seamless conversion between cryptocurrency and fiat currencies, enabling agents to conduct cross-border transactions without needing external currency exchange services, thereby reducing transaction fees and processing delays.

Example 24 is a system according to any of examples 1-23, wherein a compliance monitoring feature ensures adherence to applicable financial and data protection regulations, such as KYC (Know Your Customer), AML (Anti-Money Laundering), and GDPR (General Data Protection Regulation). This feature automatically verifies compliance status for each transaction, generating audit logs that are stored on the blockchain for regulatory transparency.

Example 25 is a system according to any of examples 1-24, wherein a customizable risk assessment algorithm evaluates the trustworthiness of agents before entering into service contracts. This risk assessment is based on historical data, ratings, transaction volume, and fraud detection metrics, providing consumer agents with a trustworthiness score before engaging in high-value transactions.

Example 26 is a system according to any of examples 1-25, wherein a smart contract deployment framework enables agents to define, deploy, and manage custom smart contracts that automate various financial processes, such as recurring payments, subscription billing, and automatic refunds. These contracts are executed on the blockchain, providing transparency, verifiability, and automation of complex financial workflows.

Example 27 is a system according to any of examples 1-26, wherein predictive analytics algorithms are utilized to forecast spending patterns and suggest budget adjustments for agents based on historical usage and market trends, helping agents make informed financial decisions.

Example 28 is a system according to any of examples 1-27, wherein a decentralized arbitration mechanism is provided for dispute resolution between agents. In the event of a contract dispute, a neutral third-party agent is randomly selected from a pool of verified agents to arbitrate, with the decision stored immutably on the blockchain.

Example 29 is a system according to any of examples 1-28, further comprising a secure document exchange system that enables agents to share encrypted project documents, contracts, and transaction records with authorized agents. Access rights and document verification are managed through the blockchain, ensuring document security and data integrity.

Example 30 is a system according to any of examples 1-29, wherein automated invoicing features allow agents to generate, send, and track invoices directly on the blockchain. The invoicing system supports multiple payment methods, provides invoice status updates, and integrates with the token metering system to calculate charges based on agent service usage.

Example 31 is a system according to any of examples 1-30, further comprising an agent reputation management system that dynamically updates each agent's profile with real-time feedback scores, transaction success rates, and client testimonials. These reputation metrics are stored on the blockchain and accessible by all agents to promote accountability and incentivize high-quality performance.

Example 32 is a system according to any of examples 1-31, wherein an automated refund management feature allows agents to process refunds based on predefined conditions or customer requests. Refund transactions are recorded on the blockchain, and the system can apply partial or full refunds based on contract stipulations, client satisfaction, or dispute resolution outcomes.

Example 33 is a system according to any of examples 1-32, wherein agents can issue secure, one-time access tokens to authorize temporary actions by third-party agents or human users. These tokens are encrypted and expire after a defined period, ensuring controlled access to sensitive actions or financial transactions on behalf of the issuing agent.

Example 34 is a system according to any of examples 1-33, wherein a machine learning-powered anomaly detection system continuously monitors agent transaction patterns, flagging suspicious or irregular activity that may indicate security risks, fraud, or potential breaches. The system can automatically halt suspicious transactions pending further verification.

Example 35 is a system according to any of examples 1-34, wherein an agent directory server supports advanced search filters, allowing consumer agents to refine searches based on skills, language capabilities, average turnaround time, project budget, and verified credentials. This directory also facilitates API access for agents to perform automated lookups of suitable collaborators or service providers.

Example 36 is a system according to any of examples 1-35, further comprising a recurring payment automation module, enabling agents to set up automatic, scheduled payments for ongoing services, such as subscriptions, periodic consulting fees, or utility payments. The module ensures timely payments and prevents service interruptions due to missed payment cycles.

Example 37 is a system according to any of examples 1-36, wherein a customizable rules-based engine allows agents to define specific spending constraints, operational limits, and automatic approval thresholds. This engine can enforce compliance by blocking transactions that violate preset rules, ensuring responsible financial management.

Example 38 is a system according to any of examples 1-37, wherein an internal messaging system enables secure communication between agents, allowing them to negotiate terms, exchange information, and provide status updates on shared projects. This communication is encrypted and stored on the blockchain, ensuring security and accountability.

Example 39 is a system according to any of examples 1-38, further comprising integration with external data sources such as financial market indices, currency exchange rates, and economic indicators, allowing agents to adjust transaction amounts, budgets, and pricing according to real-time market conditions.

Example 40 is a system according to any of examples 1-39, wherein agents can assign roles and permissions to sub-agents or human collaborators, defining specific access rights and operational limitations. This role-based access control system ensures that only authorized users can access sensitive transaction capabilities.

Example 41 is a system according to any of examples 1-40, wherein an automated quality control module ensures that deliverables meet predefined quality standards by analyzing submitted work using machine learning models. This module provides feedback, flags inconsistencies, and verifies completion, adding another layer of quality assurance.

Example 42 is a system according to any of examples 1-39, wherein an analytics dashboard presents agents with real-time insights into their financial activity, service usage, reputation trends, and pending transactions. The dashboard integrates blockchain data with visualizations, providing a clear overview of agent performance and activity.

Example 43 is a system according to any of examples 1-42, wherein an advanced, encrypted key management system securely stores and manages private keys for agents, providing secure access to blockchain wallets and preventing unauthorized access to blockchain accounts.

Example 44 is a system according to any of examples 1-43, further comprising a simulation tool that allows agents to test financial scenarios, such as budget forecasts, price adjustments, and project estimations. This tool leverages historical data and blockchain records to offer accurate predictions, aiding agents in decision-making.

Example 45 is a system according to any of examples 1-44, wherein a decentralized reputation audit system verifies the authenticity of reputation metrics on agent profiles by cross-referencing with blockchain transaction history and consensus-validated feedback.

Example 46 is a system according to any of examples 1-45, wherein agents have the option to participate in revenue-sharing or commission-based contracts, allowing them to earn compensation for referrals, collaborations, or joint projects. These revenue-sharing arrangements are automated through smart contracts on the blockchain, ensuring transparent, fair distribution of earnings.

Example 47 is a system according to any of examples 1-46, wherein a training module enables agents to leverage historical transaction data to improve their negotiation strategies, service quality, and budget management. This module uses machine learning to analyze past interactions and provides recommendations for optimizing agent performance.

Example 48 is a system according to any of examples 1-47, further comprising a multilingual translation module that allows agents to communicate and negotiate terms in multiple languages, providing real-time translation capabilities that enable cross-border and cross-language transactions.

Example 49 is a system according to any of examples 1-48, wherein agents are equipped with a customizable financial reporting feature, allowing them to generate detailed reports on revenue, expenses, outstanding payments, and service metrics. These reports can be shared with clients or stakeholders as needed.

Example 50 is a system according to any of examples 1-49, wherein a fallback protocol ensures continuity of service in case of network disruptions or partial system failures, allowing agents to execute essential functions with stored configurations and recover completed transactions once connectivity is restored.

Example 51 is a system according to any of examples 1-50, wherein blockchain-based escrow services are utilized to securely hold funds during the execution of service contracts. Payments are automatically released to the producer agent once predefined milestones are met, or the entire project is completed as agreed, with the consumer agent's approval or through a third-party quality assurance (QA) agent.

Example 52 is a system according to any of examples 1-51, wherein an automated dispute resolution mechanism powered by blockchain-based arbitration services enables third-party agents to resolve payment or contractual disputes between agents. The arbitration process uses smart contract terms, transaction history, and consensus from both parties to enforce a fair decision.

Example 53 is a system according to any of examples 1-52, wherein a blockchain-based payment channel network (such as Lightning Network) is integrated to allow for off-chain microtransactions and fast, low-cost payments between agents. This enables high-frequency, low-value transactions to occur without burdening the main blockchain with excessive transaction costs or delays.

Example 54 is a system according to any of examples 1-53, wherein tokenized assets, such as stablecoins, are utilized as a medium of exchange within the agent ecosystem. These tokens can represent fiat currencies or other assets, and they enable secure, transparent, and verifiable transactions between agents, avoiding the volatility often associated with other cryptocurrencies.

Example 55 is a system according to any of examples 1-54, wherein blockchain wallets within the system are enabled to support multi-signature features, requiring multiple agents' signatures before payments can be authorized or transactions completed. This enhances security by ensuring that no single agent has unilateral control over funds or transactions.

Example 56 is a system according to any of examples 1-55, wherein a token-based reputation system allows agents to accumulate reputation tokens based on positive transaction outcomes, work quality, and client feedback. These tokens are stored on the blockchain and can be traded, used for accessing premium services, or exchanged for discounts in future transactions.

Example 57 is a system according to any of examples 1-56, wherein the system integrates with third-party payment gateways (such as PayPal, Stripe, or traditional bank transfers) through API connectors, enabling agents to make or receive payments from outside the blockchain ecosystem. These payments are securely processed and recorded on the blockchain, ensuring full transparency and auditability.

Example 58 is a system according to any of examples 1-57, wherein an automatic tax compliance module calculates and withholds appropriate tax amounts from transactions based on jurisdiction, contract type, and applicable laws. These withheld taxes are recorded on the blockchain and can be directly remitted to the appropriate authorities through an integrated blockchain-based payment system.

Example 59 is a system according to any of examples 1-58, wherein agents can issue and manage blockchain-based invoices, which include detailed transaction information, tax rates, and payment instructions. These invoices are automatically generated, signed, and shared through secure blockchain channels to ensure the integrity and traceability of the billing process.

Example 60 is a system according to any of examples 1-59, wherein blockchain smart contracts automatically perform conversion between multiple payment methods (e.g., cryptocurrency, PayPal, credit cards) based on the preference of the consumer agent or producer agent. This conversion is facilitated by decentralized exchanges (DEXs) or integrated third-party providers.

Example 61 is a system according to any of examples 1-60, wherein a payment routing algorithm selects the optimal payment method based on transaction cost, processing speed, and available balances in agents' wallets. This allows for efficient and cost-effective payment processing, especially for cross-border transactions.

Example 62 is a system according to any of examples 1-61, wherein the blockchain payment network supports peer-to-peer (P2P) lending functionality, allowing agents to lend or borrow funds using smart contracts. Borrowers can repay the loans according to agreed-upon terms, while lenders earn interest on their contributions, with all transactions and loan terms recorded immutably on the blockchain.

Example 63 is a system according to any of examples 1-62, wherein agents can use blockchain-based loyalty and rewards programs to incentivize frequent transactions. These programs use blockchain tokens as rewards, which can be redeemed for services, discounts, or converted into cryptocurrency or fiat currency.

Example 64 is a system according to any of examples 1-63, wherein agents can issue payment requests in the form of smart contract-based invoices that include specific terms, such as due dates, payment methods, and penalty clauses for late payment. These requests are digitally signed and transmitted over the blockchain, ensuring trust and transparency between involved parties.

Example 65 is a system according to any of examples 1-64, wherein multi-blockchain interoperability is achieved through cross-chain bridges, allowing agents to execute transactions and interact with assets on different blockchains (e.g., Ethereum, Bitcoin, Solana). This enables agents to make payments across a wider range of blockchain platforms without being restricted to a single network.

Example 66 is a system according to any of examples 1-65, wherein blockchain-based smart contracts are used to implement subscription management systems, where payments are automatically charged to the consumer agent's blockchain wallet at regular intervals. These subscription contracts are self-executing and enforce service delivery until canceled by either party.

Example 67 is a system according to any of examples 1-66, wherein blockchain consensus algorithms are used to verify transactions and confirm payment processing, ensuring that each transaction is validated by multiple participants (e.g., proof of stake, proof of work). This process enhances the security, trustworthiness, and decentralization of financial interactions between agents.

Example 68 is a system according to any of examples 1-67, wherein an automated wealth management service allows agents to invest funds from their blockchain wallets in decentralized finance (DeFi) protocols. These funds can be allocated to yield farming, staking, or liquidity provision in DeFi platforms, with the investment outcomes recorded on the blockchain.

Example 69 is a system according to any of examples 1-68, wherein an AI-powered financial advisory service recommends optimized payment strategies, savings plans, and investment opportunities based on agent transaction history, market trends, and available blockchain-based financial products.

Example 70 is a system according to any of examples 1-69, wherein blockchain-based automated charity donation functionality enables agents to donate a percentage of their earnings or transaction fees to designated charitable causes. The donation is recorded and verified on the blockchain for transparency and accountability.

Example 71 is a system according to any of examples 1-70, wherein agents can leverage blockchain identity verification tools to authenticate the identities of other agents or human participants before initiating payment transactions, ensuring that each party involved is legitimate and verified.

Example 72 is a system according to any of examples 1-71, wherein blockchain is utilized to facilitate decentralized insurance contracts, where agents can participate in risk-pooling agreements. Payments for claims are processed by smart contracts, and the blockchain ensures transparent and secure management of claims and payouts.

Example 73 is a system according to any of examples 1-72, wherein agents can use blockchain-based payment services to securely perform international remittances, reducing transaction fees and processing time compared to traditional cross-border payment methods. These remittances are recorded on the blockchain to ensure transparency and traceability.

Example 74 is a system according to any of examples 1-73, wherein agents can issue and manage crypto-backed loans using smart contracts. The collateral for such loans is recorded on the blockchain, and the loan repayment terms are automatically enforced by the contract, ensuring security and reducing the need for intermediary banks.

Example 75 is a system according to any of examples 1-74, wherein the system supports decentralized autonomous organizations (DAOs) to facilitate group decision-making about the use of funds or the distribution of earned revenue. Agents can participate in governance decisions by voting on proposals stored on the blockchain.

Example 76 is a system according to any of examples 1-75, wherein blockchain-backed payment systems enable microtransactions for agents to access granular, on-demand services. These services can include digital content, API usage, or software features, with the blockchain ensuring transparency and accountability for all transactions.

Example 77 is a system according to any of examples 1-76, wherein a pass-through subcontract is settled as an atomic split from escrow to producer and third party upon joint attestation.

Example 78 is a system according to any of examples 1-77, wherein subscription charges on a cadence, consults metering for overage, triggers dunning under risk, and pauses workflows in the orchestrator on payment failure.

Example 79 is a system according to any of examples 1-78, wherein metered billing decrements a deposit by per-item proofs aggregated into Merkle roots anchored on the blockchain.

Example 80 is a system according to any of examples 1-79, wherein a retainer issues credits when response-time SLAs are breached as attested by milestones.

Example 81 is a system according to any of examples 1-80, further comprising foreign exchange conversion via Remote Services/Servers with a collar refund when executed rates violate bounds.

Example 82 is a system according to any of examples 1-81, further comprising KYC checks via a compliance provider that must pass before pass-through settlement is released.

Example 83 is a system according to any of examples 1-82, wherein the directory ranks agents using reputation events derived from escrow outcomes and dispute results anchored on the blockchain.

Example 84 is a system according to any of examples 1-83, wherein the orchestrator supports sealed-bid auctions with commit-reveal, masking bidders in risk, with bid artifacts anchored on the blockchain.

Example 85 is a system according to any of examples 1-84, wherein disputes are adjudicated by the dispute/arbitration module and partial refunds or credits are issued by the payments adapter via the provider to the bank.

### Other Examples

Example A—Agent-to-Agent Price Negotiation (sealed-bid):

Agent Orchestrator posts RFQ for “100 annotated images≤$800, SLA 24 h.” Three submit commit hashes to blockchain layer. During reveal, bids are $750, $680, $710. 1090 confirms identity and caps. Agent orchestrator selects $680 and calls smart-contract manager to deploy digital service contract and escrow (escrow, 50/50 milestones).

Example B—Performance-Based Payout:

Milestone 1 requires F1≥0.80. third-party verifier signs attestations with score 0.83. Third-party verifier releases 40% from escrow using payments adapter; audit store stores attestation and receipt.

Example C—Pass-Through to Third Party:

Producer agent subcontracts labeling to third-party verifier. Digital service contract generated via smart-contract manager encodes a 70/30 split. On joint attestation, escrow executes an atomic split payout across ACH or wire transfer to producer agent and crypto rail (e.g., to stablecoin) to third-party verifier in one commit.

Example D—Subscription Payments (Agent→Agent):

Producer offers “Model-Ops Support” at $1,500/month via subscription module, overage $0.10/MB. Payments adapter bills card via card rail monthly.

Subscription ledger records receipts. On failure, Risk & Guardrails Engine runs dunning and agent orchestrator pauses job routing.

Example E—Metered/Information-Based Payment:

Consumer buys 10,000 embeddings at $0.0005 each. Each batch generates leaves;

Billing & Metering module anchors a Merkle root to blockchain. Smart-contract manager decrements deposit dictated by deposit module per inclusion proof.

Example F—Retainer with SLA Credits:

Retainer module operates on 24/7 pager duty. Service level agreement generates 10-minute response. Credit via credit module=5% fee per breach capped at 15% per month. A 13-minute response triggers a 5% credit on next invoice.

Example G—Bid Deposit for Seriousness:

RFQ demands deposit of $500 from each bidder; non-selected bidders receive auto-refund via payments adapter after reveal; winner's deposit converts to partial funding of escrow.

Example H—Human-in-the-Loop Hiring:

A human customer instructs consumer agent to “hire a video editor for a 2-minute teaser.” Agent orchestrator runs RFQ. Digital service contract includes pass-through to a verified human vendor. Risk & Guardrails Engine performs KYC checks on third-party verifier via compliance provider module. Payments adapter pays third-party by wire upon attestation verification.

Example I—Agent→Agent→Agent Transmission:

Producer agent outsources caption translation to a language agent. Digital service contact encodes three-way split (60/25/15). On attestations (caption+translation checks), escrow releases an atomic tripartite split.

Example J—Reverse Auction (Commit-Reveal):

Agent orchestrator conducts a reverse sealed auction. Risk & Guardrails Engine masks bidder identities until reveal, preventing collusion. Audit store stores commit and reveal artifacts. Blockchain anchors commitments.

Example K—Cross-Chain Microservices:

Work escrowed on chain A and makes payout to third-party verifier on chain B. Bridge releases wrapped funds after SLA check. Payments adapter generates on-chain receipts and audit store stores proof hashes.

Example L—FX with Collar Refund:

Contract currency is EUR; consumer funds USD. FX quotes 1.0940 with ±50 bps collar. Execution settles at 1.1010 (breach); Smart-contract manager issues credit refund equal to overage difference and records event.

Example M—KYC-Gated Subcontract:

Risk & Guardrails engine queries compliance provider and subcontractor 1220 passes. Smart-contract manager flips pass_through_enabled=true; otherwise, escrow holds funds until remediation.

Example N—Idempotence after Net Flap:

Card capture succeeds but internet drops. Payments adapter retries with same commit_id. Audit store maps to original capture.

Example O—Directory Ranking and Reputation:

Agent directory ranks producer agent by reputation events (escrow success %, dispute rate). Agent orchestrator auto-shortlists top-K.

Example P—Performance Ladder:

Escrow releases 20% at prototype, 30% at mid-QA, 50% at final acceptance; failure to meet F1≥0.90 on final triggers 10% haircut. Oracle evidence supplies scores while attestation module aggregates attestations.

Example Q—Subscription Upgrade with Step-Up:

Consumer agent upgrades service from Basic to Pro. Risk & Guardrails Engine requires step-up verification. Payments adapter triggers SCA for cards before adjusting subscription billing.

Example R—Retainer Rollover:

Retainer module managing retainer rolls over 30% unused hours; Risk & Guardrails engine enforces monthly cap. Credits never exceed $2,000/month.

Example S—Multi-Rail Atomic Split:

A payment splits 40% to card (producer), 60% to crypto (verifier).

Payment adapter coordinates an all-or-nothing settlement. Audit store stores both receipts atomically.

Example T—Escrow-Backed Warranty:

Post-delivery warranty window keeps 10% in escrow. If no defects signaled, Smart-contract manager releases remainder; if defects found, Dispute module adjudicates refund amount.

Example U—SLA-Backed Incident Response:

Incident tickets must acknowledge in 5 minutes and resolve in 30. System checks timestamps, attestations, computes breaches. Credits are auto-applied according to a credit schedule and capped as per retainer configuration.

The foregoing description has been presented for purposes of illustration. It is not exhaustive and does not limit the system to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the system being indicated by the following claims.

What is claimed is:

1. A computer system comprising:
a processor;
a memory; and
a non-volatile storage device;
wherein the computer system comprises computer-executed instructions configured to execute a software platform comprising:
a blockchain layer, and
an agent orchestrator,
wherein the agent orchestrator is configured to conduct one or more financial transactions with a large language model (LLM) via one or more AI agents, or another AI agent of the one or more agents; and
wherein the system records the financial transaction events on the blockchain layer.

2. The system of claim 1, wherein the financial transactions comprise one or more payments from the AI agent to the LLM; and
wherein the software platform further comprises a payments adapter configured to settle the financial transactions with a payment provider or a bank via one or more of a card rail, a crypto rail, or an ACH or wire transfer.

3. The system of claim 1, further comprising one or more of:
a smart-contract manager configured to generate smart-contracts of the financial transactions;
a risk module configured to generate transaction policies;
an audit store configured to store one or more of logs and hashes; and
a dispute module configured to resolve transaction disputes.

4. The system of claim 3, wherein the audit store preserves inclusion proofs for metered units, consent events, and payout identifiers, thereby providing tamper-evident dispute materials.

5. The system of claim 3, wherein the payment adapter performs multi-rail atomic splits across one or more of the card rail, the ACH or wire transfer, or the crypto in a single commit and records receipts of the multi-rail atomic splits in the audit store.

6. The system of claim 3, wherein the risk module enforces one or more of per-quote, per-milestone, and per-period spending caps for the financial transactions.

7. The system of claim 3, wherein the financial transactions include subscription services, and wherein the risk module is configured to facilitate step-up verification for upgrades to the subscription services.

8. The system of claim 5, wherein the smart-contract manager is configured to perform an anti-replay service which prevents duplicate payments by checking one or more logs in the audit store.

9. The system of claim 2, further comprising:
wherein the payments adapter is configured to facilitate funding for one or both of a deposit or an escrow for the one or more financial transactions;
wherein the system verifies one or more milestones of the one or more financial transactions; and
wherein the payments adapter is configured to resolve one or more payouts of the one or more financial transactions.

10. The system of claim 9, wherein at least one of the one or more payouts is a performance-based payout; and
wherein the performance-based payout is released from escrow upon receipt of one or more oracle evidence checks or one or more verifier attestations.

11. A software executed method comprising:
providing a computer system comprising:
a processor;
a memory; and
a non-volatile storage device;
wherein the computer system comprises computer-executed instructions configured to execute a software platform comprising:
a blockchain layer, and
an agent orchestrator,
wherein the agent orchestrator is configured to conduct one or more financial transactions with a large language model (LLM) via one or more AI agents or with another AI agent of the one or more AI agents; and
wherein the system records smart-contract and settlement events on the blockchain layer;
publishing, via the agent orchestrator, a request for quote (RFQ);
receiving one or more quotes from a first agent; and
compiling a smart-contract via a smart-contract manager.

12. The software method of claim 11, further comprising:
funding one or both of a deposit or an escrow for the one or more financial transactions;
verifying one or more milestones of the one or more financial transactions; and
resolving one or more payouts of the one or more financial transactions via a payments adapter.

13. The software method of claim 12, wherein at least one of the one or more payouts is a performance-based payout; and
wherein the performance-based payout is released from escrow upon receipt of one or more oracle evidence checks or one or more verifier attestations.

14. The software method of claim 12, wherein the payments adapter is configured to settle the financial transactions with a payment provider or a bank via one or more of a card rail, a crypto rail, or an ACH or wire transfer.

15. The software method of claim 11, wherein the software platform further comprises one or more of:
a smart-contract manager configured to generate smart-contracts of the financial transactions;
a risk module configured to generate transaction policies;
an audit store configured to store one or more of logs and hashes; and
a dispute module configured to resolve transaction disputes.

16. The software method of claim 15, wherein the audit store preserves inclusion proofs for metered units, consent events, and payout identifiers, thereby providing tamper-evident dispute materials.

17. The software method of claim 12, wherein the payment adapter performs multi-rail atomic splits across one or more of the card rail, the ACH or wire transfer, or the crypto in a single commit and records receipts of the multi-rail atomic splits in the audit store.

18. The software method of claim 15, wherein the risk module enforces one or more of per-quote, per-milestone, and per-period spending caps for the financial transactions.

19. The software method of claim 11, wherein the financial transactions include subscription services, and wherein the risk module is configured to facilitate step-up verification for upgrades to the subscription services.

20. The software method of claim 15, wherein the smart-contract manager is configured to perform an anti-replay service which prevents duplicate payments by checking one or more logs in the audit store.
